(19) United States
(12) Patent Application Publication
(10) Pub. No.: US 2009/0087010 A1
(43) Pub. Date: Apr. 2, 2009

(54) CARRIER CHIP WITH CAVITY

(76) Inventors: Mark Vandermeulen, Hamilton (CA); David Roy, Port Colborne (CA); Charles Divita, Burlington (CA)

Correspondence Address: PATENT GROUP 2N;JONES DAY, NORTH POINT, 901 LAKESIDE AVENUE, CLEVELAND, OH, 44114, US

(21) Appl. No.: 11/862,471

(22) Filed: Sep. 27, 2007

(51) Int. Cl. H04R 1/02

(52) U.S. Cl. 381/360

(57) ABSTRACT

A microphone apparatus includes a carrier chip and a microphone chip. The carrier chip includes a substrate with parallel top and bottom surfaces, a metallization layer overlying the top surface, and a cylindrical cavity that is bored through the top surface and the metallization layer and partially through the carrier substrate. The microphone chip includes a substrate with parallel top and bottom surfaces, a cylindrical cavity extending from the microphone substrate top surface to the microphone substrate bottom surface, and a diaphragm attached to the microphone substrate bottom surface and extending across the microphone cavity. The microphone chip is fixed to the carrier chip, with the microphone cavity overlying the carrier cavity, and the diaphragm covering the carrier cavity and electrically connected to the metallization layer.

### TECHNICAL FIELD

This application relates to carrier chips with cavities.

### BACKGROUND

Hybrid circuits can utilize thick film technology. A thick film circuit can be fabricated by patterning conductive, resistive and/or dielectric paste materials onto a ceramic substrate in order to form thick film conductors, and possibly also to form passive circuit components, such as resistors and capacitors. The thick film material can include a functional component that determines its electrical properties, a binder component that provides adhesion between the thick film material and the ceramic substrate, and a vehicle to establish printing characteristics. Typically, the thick film paste is patterned on the ceramic substrate, dried to evaporate the solvents from the printed film, and fired in an oven. A hybrid circuit can then be fabricated by soldering conventional electronic components, active or passive, to thick film bonding pads printed on the substrate with conductive thick film materials.

The functional component in conductive thick film materials is typically a fine metal powder, such as copper, gold, silver, palladium-silver, platinum-silver, palladium-gold, or platinum-gold. Bonding pads and circuit traces are typically patterned from such thick film materials by screen printing the conductive metallic paste onto a ceramic substrate, although other patterning methods can be used, such as spin coating or a combination of screen printing and wet chemical etching.

A solder mask layer is then typically added to cover the conductive traces and separate adjacent bonding pads. The solder mask layer is generally screen printed in a pattern onto the ceramic substrate and cured, leaving an area of bare substrate between the solder mask layer and the thick film bonding pads. In this manner, the thick film pads are left entirely uncovered by the solder mask layer, and may be coated with a layer of solder by immersing the entire circuit in a solder bath. Because the solder mask layer typically covers everything but the bonding pads, the pads can be coated with solder without causing solder shorts between adjacent pads and traces.

A hybrid circuit can then be formed by aligning the connection terminals of a surface-mount component onto the bonding pads, and reflowing the solder layer to form solder joints between the thick film pads and connection terminals.

### BRIEF DESCRIPTION OF THE DRAWINGS

FIG. 1 is a perspective view of an audio transducer, including a microphone chip, an ASIC chip and a carrier chip that are attached together.

FIG. 2 is a perspective view of the three chips detached from each other.

FIG. 3 is a sectional view taken at line 3-3 of FIG. 2.

FIG. 4 is a sectional view taken at line 4-4 of FIG. 1.

FIG. 5 is a flow chart showing steps of a method for fabricating the transducer.

FIG. 6 is a top view of one layer of the carrier chip.

### DESCRIPTION

### Components of an Audio Transducer

The microphone apparatus 10 shown in FIG. 1 has parts that are examples of the elements recited in the claims. The apparatus thus includes examples of how a person of ordinary skill in the art can make and use the claimed invention. It is described here to meet the requirements of enablement and best mode without imposing limitations that are not specified in the claims.

The microphone apparatus 10 is an audio transducer. It includes a microphone chip 12 that converts sound to a raw electrical signal, an ASIC (Application Specific Integrated Circuit) chip 14 that converts the raw signal to a processed signal, and a carrier chip 16. The carrier chip 16 supports the other chips 12 and 14 and electrically and physically (i.e., mechanically) couples the other chips 12 and 14 together.

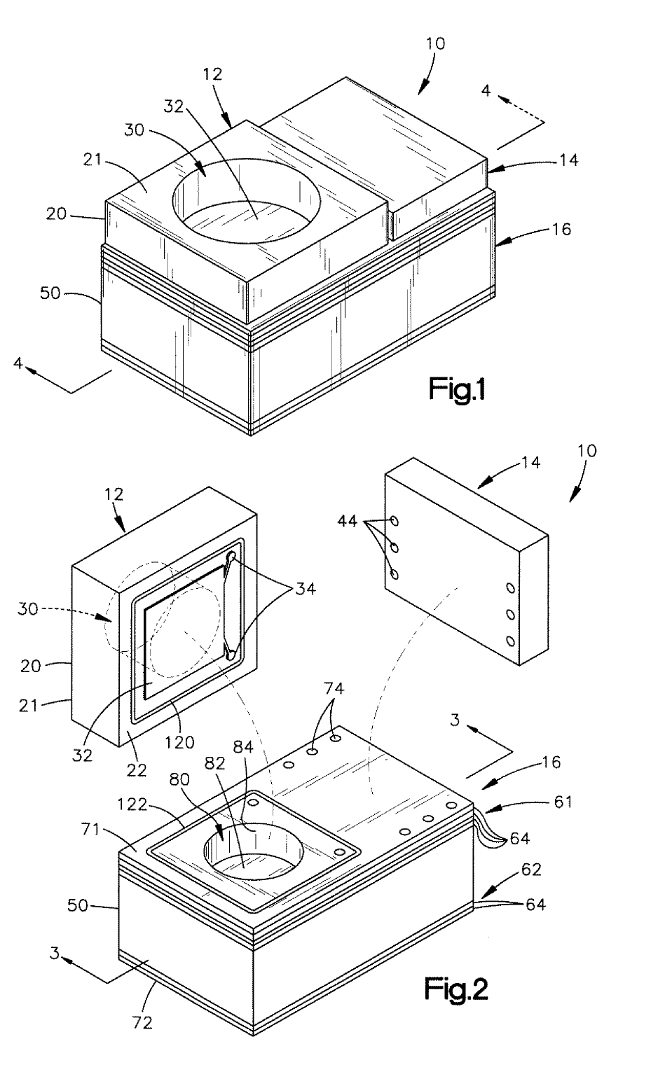

As shown in FIG. 2, the microphone chip 12 includes a ceramic substrate 20 with parallel top and bottom surfaces 21 and 22. The top and bottom surfaces 21, 22 are rectangular, and preferably square. A cylindrical microphone cavity 30 extends fully through the substrate 20, from the top surface 21 to the bottom surface 22. A diaphragm 32 is attached to the bottom surface 22 and extends across the cavity 30. Two terminal pads 34 on the bottom surface 22 are electrically connected to the diaphragm 32.

The ASIC chip 14 processes the raw signal by amplifying and offsetting it. The ASIC has terminal pads 44 for drawing supply power, inputting the raw signal, and outputting the processed signal.

The carrier chip 16 is shown in FIG. 3. It includes a substrate 50, preferably of fired ceramic, with top and bottom surfaces 51 and 52. Each surface 51, 52 is covered with a metallization layer 61, 62 that includes multiple levels 64. Each level 64 includes a conductor layer 66 and a dielectric layer 68. The conductor layers 66 can entail thick film technology or thin film technology for creating traces and passive components. Vias 70 extend through the substrate 50 to electrically interconnect aligned contact points in the top and bottom metallization layers 61 and 62. Each via 70 comprises a through-hole filled with a conductive material, preferably a non-shrink thick-film-based material.

The top-most and bottom-most layers 64 respectively define top and bottom surfaces 71 and 72 of the carrier chip 16. The top surface 71 has solder pads 74 for connecting to the terminal pads 34 and 44 of the microphone and ASIC chips 12 and 14. The bottom surface 72 has terminal pads 76 for drawing supply power and outputting the processed signal.

A carrier cavity 80 extends through the top metallization layer 61 and partially through the substrate 50. It is bounded by a flat bottom surface 82 and a cylindrical side surface 84. The bottom surface 82 is parallel with the carrier substrate's top and bottom surfaces 51, 52. The carrier cavity's side surface 84 is bounded mainly by the substrate 50. In this example, the cavity's side surface 84 is bounded also by an edge 91 of the top metallization layer 61, comprising edges of conductor layers 66 and/or dielectric layers 68 that comprise the top metallization layer 61. In this example, the edge 91 of the metallization layer 61 bounds the cavity 80 about the entire circumference of the cavity 80, with portions the conductor layers 66 and/or dielectric layers 68 extending up to the carrier cavity 80. In alternative examples, the metallization layer 61 can be spaced radially away from the carrier cavity 80, so that boring the cavity 80 does not include boring through the metallization layer 61.

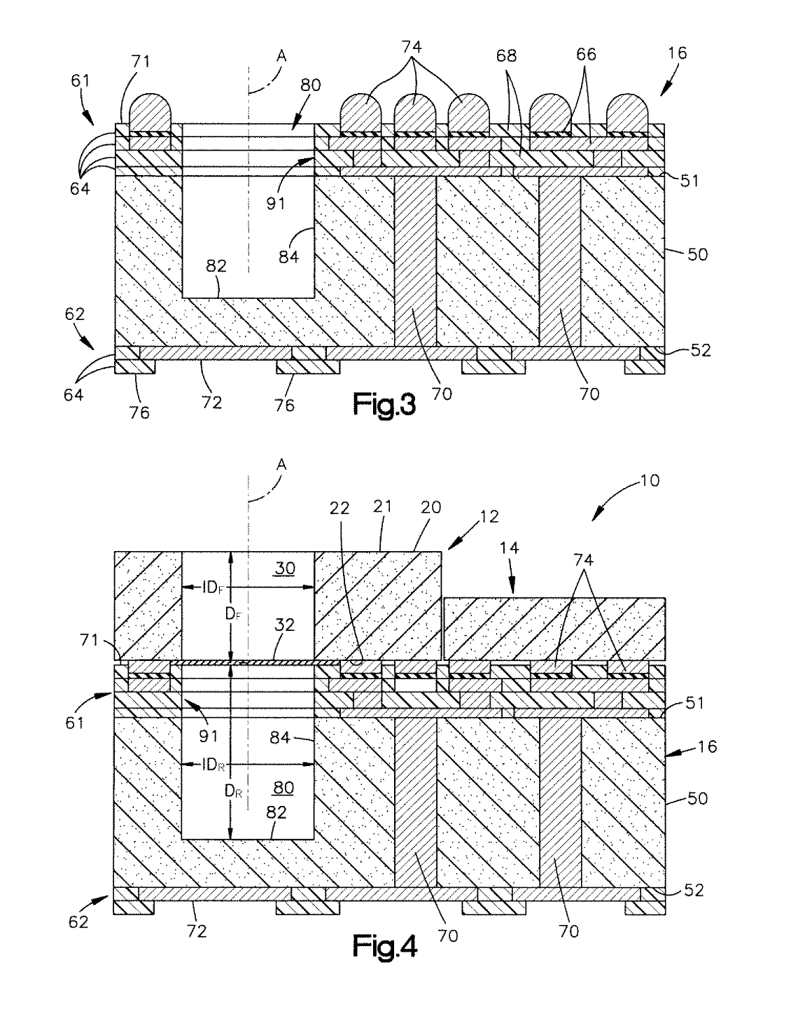

FIG. 4 is a sectional view of the three chips 12, 14 and 16 assembled together. The microphone chip 12 is fixed to the top surface 71 of the carrier chip 16. The microphone chip 12 and its diaphragm 32 completely cover the carrier cavity 80. The microphone cavity 30 is aligned with the carrier cavity 80 in that it is centered on a central axis A of the carrier cavity 80.

The microphone cavity 30 functions as a front acoustic cavity in front of the diaphragm 32, and the carrier cavity 80 functions as a rear acoustic cavity behind the diaphragm 32. In this example, the cavities 30 and 80 are the same shape. They are cylindrical, which reduces corner stresses that can develop during fabrication. The inner diameters ID_{F} and ID_{R} of the front and rear cavities 30 and 80 are about 1 mm. They differ by less than 10% and are preferably equal. The depths D_{F} and D_{R} of the front and rear cavities 30 and 80 are about 0.2 mm and 0.3 mm, respectively. In this example, the cavities 80 do not contain any terminal pad, trace or metallization layer. Nor do the walls of the cavities 30 and 80 support any terminal pad, trace or metallization layer. Even the top metallization layer 61, whose edge 91 bounds the carrier cavity 80, is not supported by any of the cavity's surfaces 82 and 84 but instead by the carrier substrate's top surface 51.

### Fabrication Method

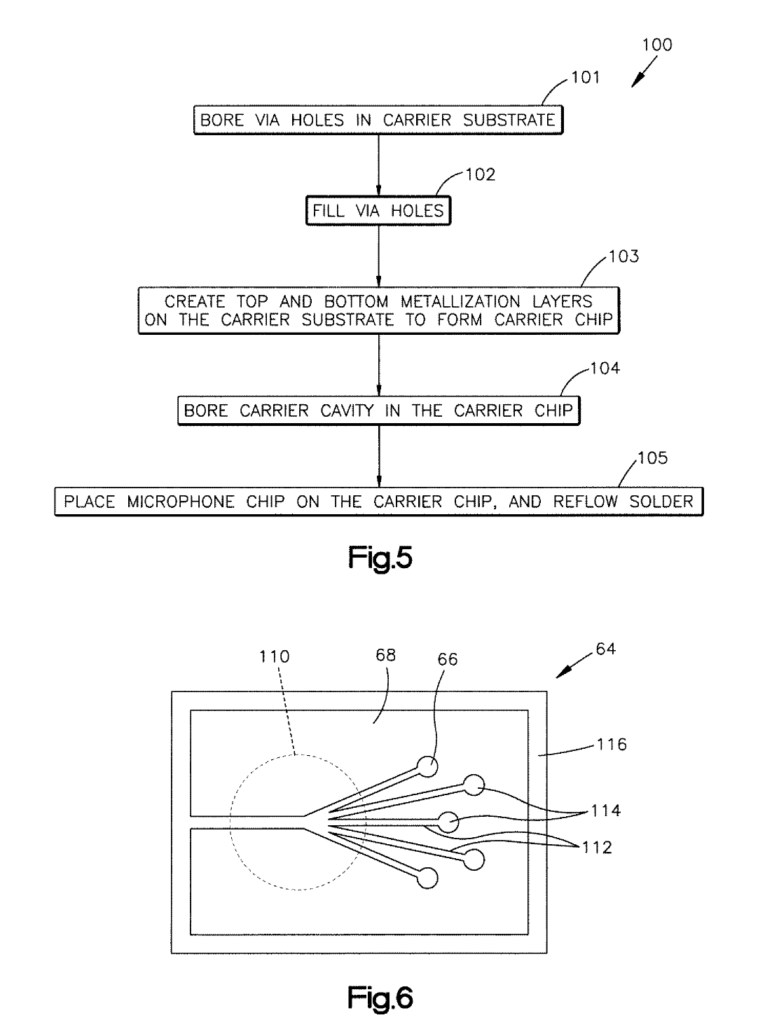

FIG. 5 shows an example method 100 for fabricating the microphone apparatus 10 of FIG. 4. It has the following steps performed in the following order:

In a first step 101, a blank substrate material 50 is laser machined to create the via holes 70, which extend from the substrate's top surface 51 to its bottom surface 52.

In a second step 102, the via holes 70 are filled with conductive material described above.

In a third step 103, the top and bottom metallization layers 61 and 62 are formed on the top and bottom surfaces 51 and 52 of the substrate 50. This can be done using electroplating, chemical etching, or photochemical printing.

As shown in FIG. 6, this third step 103 can apply portions of the conductor layers 66 and/or dielectric layers 68 over, and totally cover, the area 110 of the substrate 50 that will be removed in a later boring step 104. Doing so enables the conductor layer 66 to include temporary electrical shorts 112 between pads 114. These shorts 112 can be beneficial during the fabrication process but unacceptable in the finished product. An example use for these electrical shorts 112 is for electrically charging the pads 114 during electroplating by applying a charge to a single point on a peripheral trace 116, for the shorts 112 to distribute the charge to the pads 114.

In a fourth step 104 in FIG. 5, a cavity 80 is bored in the carrier chip 16. This boring step 104 includes boring through any portion of the conductor layers 66 and dielectric layers 68 that overlaid the cavity area 110 (FIG. 6). Any shorts 112 that extended through the cavity area 110 are thus broken before the chip 16 is used.

This fourth step 104 is preferably done by ultrasonic milling, which applies less heat to the chip 16 than alternate boring methods such as laser milling. The lower temperature yields less deformation of adjacent structures—such as the substrate surface 51, metallization layer 61 and cavity walls 82, 84—than other methods that produce higher temperatures. This decreased deformation enables components to be located closer to the edge of the cavity 80 than if a hotter boring method were used. The decreased deformation also improves accuracy and repeatability of the cavity's volume, which can improve sound quality.

In a fifth step 105, the microphone chip 12 is physically and electrically coupled to the carrier chip 16. In this step, the microphone chip 12 is placed on the carrier chip 16, with the microphone pads 34 (FIG. 2) aligned with corresponding solder pads 74 of the carrier chip 16, with the microphone cavity 30 aligned with the carrier cavity 80, and with a square-ring pad 120 on the microphone chip 12 surrounding the microphone cavity 30 aligned with a square-ring solder pad 122 on the carrier chip 16 surrounding the carrier cavity 80. Similarly, the ASIC chip 14 is positioned on the carrier chip 16, with its pads 44 aligned with corresponding solder pads 74 on the carrier chip 16. The apparatus 10 is then heated to reflow the solder. This electrically and physically couples the microphone chip 12 and the ASIC chip 14 to the carrier chip 16. The square-ring solder bead 122 surrounding the carrier cavity 80 forms an air-tight seal between the microphone chip 12 and the carrier chip 16.

### Comparison to Other Methods

By fabricating the surface metallization before boring the cavity, the planarity of the top surface can be maintained, even up to the top edge of the cavity. The planar surface allows photosensitive materials and patterning techniques to be used so that high density high precision circuitry can be generated.

The lower temperature of ultrasonic milling relative to other boring methods reduces the chance of thermal damage to adjacent portions of the metallization layer. Since the substrate is fired ceramic, not green tape, the lower temperature eliminates shrinkage factors to compensate for. This allows more precise and repeatable metallization features and cavity chambers, in terms of diameter, depth and x/y placement, to be fabricated across a large area. The higher precision enables higher density features. The improved planarity and reduced damage near the cavity enables circuitry to be located closer to the edge of the cavity. The improved planarity near the cavity edge further enables photosensitive materials and patterning techniques to be used so that high-density high-precision circuitry can be generated. The lower temperature further improves dimensional control of the cavity chamber in x, y and z directions, especially relative to features of the surface metallization.

Compared to LTCC (low temperature co-fired ceramic) and HTCC (high temperature co-fired ceramic) methods, this method provides better precision on 1) the layered interconnect structure (tighter layer to layer tolerances), 2) integrated cavity x/y placement (relative to the surface metallization), 3) cavity diameter, and 4) cavity depth.

Compared to silicon based substrates, the ceramic substrate 1) enables higher performing electrical connections from topside to bottom-side interconnect, 2) is more mechanically robust, and 3) withstands higher processing temperatures.

Compared to PCBs (printed circuit boards), this method provides 1) closer thermal expansion match to silicon, 2) higher density and higher precision circuitry, 3) can withstand higher process temperature, 4) yields more precise cavity features

### Summary

Accordingly, the apparatus of FIGS. 1-4 and the method of FIG. 5 provide an example of the following features: A carrier chip includes a substrate with parallel top and bottom surfaces, and a metallization layer overlying the top surface. A cylindrical cavity is bored through the top surface and the metallization layer and partially through the carrier substrate. A microphone chip includes a substrate with parallel top and bottom surfaces, a cylindrical cavity extending from the microphone substrate top surface to the microphone substrate bottom surface, and a diaphragm attached to the microphone substrate bottom surface and extending across the microphone cavity. The microphone chip is fixed to the carrier chip, with the microphone cavity overlying the carrier cavity, and the diaphragm covering the carrier cavity and electrically connected to the metallization layer. The inner diameter ID_{F} of the microphone cavity differs from the inner diameter ID_{R} of the carrier cavity by less than 10%. An edge of the metallization layer bounds the carrier cavity.

The apparatus and the method further provide examples of the following method steps: In one step, a metallization layer is formed on a top surface of a substrate. In a subsequent step, a cavity is bored from the top surface partially through the substrate. The metallization layer includes a conductor layer, and the boring step includes boring through the conductor layer into the substrate. The metallization layer includes a dielectric layer, and the boring step includes boring the cavity through the dielectric layer into the substrate. The cavity is cylindrical. The substrate is of fired ceramic material. A further step entails physically and electrically coupling a microphone chip to the metallization layer, with the microphone chip completely covering the cavity. A diaphragm of the microphone chip completely covers the cavity by the coupling step. The cavity contains no trace, pad or metallization layer after the coupling step.

The apparatus further provides an example of the following features. A carrier chip includes a substrate with parallel top and bottom surfaces, a cylindrical cavity extending from the substrate top surface partially through the carrier substrate, and a metallization layer overlying the carrier top surface. A microphone chip includes a substrate with parallel top and bottom surfaces, a cylindrical cavity extending from the microphone substrate top surface to the microphone substrate bottom surface, and a diaphragm. The diaphragm is attached to the microphone substrate bottom surface and extends across the microphone cavity. The microphone chip is fixed to the carrier chip, with the microphone cavity overlying the carrier cavity, and the diaphragm covering the carrier cavity and electrically connected to the metallization layer.

This written description uses examples to disclose the invention, including best mode, and to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. A microphone apparatus comprising:
a carrier chip that includes a substrate with parallel top and bottom surfaces, a metallization layer overlying the top surface, and a cylindrical cavity that is bored through the top surface and the metallization layer and partially through the carrier substrate; and
a microphone chip that includes a substrate with parallel top and bottom surfaces, a cylindrical cavity extending from the microphone substrate's top surface to the microphone substrate's bottom surface, and a diaphragm attached to the microphone substrate bottom surface and extending across the microphone cavity;
the microphone chip being fixed to the carrier chip, with the microphone cavity overlying the carrier cavity, and the diaphragm covering the carrier cavity and electrically connected to the metallization layer.

2. The apparatus of claim 1 wherein the carrier cavity contains no trace, pad or metallization layer.

3. The apparatus of claim 1 wherein the inner diameter of the microphone cavity differs from the inner diameter of the carrier cavity by less than 10%.

4. The apparatus of claim 1 wherein the inner diameter of the microphone cavity equals the inner diameter of the carrier cavity.

5. The apparatus of claim 1 wherein an edge of the metallization layer bounds the carrier cavity about the entire circumference of the carrier cavity.

6. The apparatus of claim 1 wherein the carrier substrate is of fired ceramic material.

7. A method comprising:
forming, on a top surface of a substrate, a metallization layer; and
subsequently boring a cavity through the top surface and partially through the substrate.

8. The method of claim 7 wherein the metallization layer includes a conductor layer, and the boring step includes boring the cavity through the conductor layer into the substrate.

9. The method of claim 7 wherein the metallization layer includes a dielectric layer, and the boring step includes boring the cavity through the dielectric layer into the substrate.

10. The method of claim 7 wherein the cavity is cylindrical.

11. The method of claim 7 wherein the boring includes ultrasonic milling.

12. The method of claim 7 wherein the substrate is of fired ceramic material.

13. The method of claim 7 further comprising physically and electrically coupling a microphone chip to the metallization layer, with the microphone chip completely covering the cavity.

14. The method of claim 13 wherein a diaphragm of the microphone chip completely covers the cavity after the coupling step.

15. The method of claim 13 wherein the cavity contains no trace, pad or metallization layer after the coupling step.
